(19) United States
(12) Patent Application Publication
(10) Pub. No.: US 2021/0274761 A1
(43) Pub. Date: Sep. 9, 2021

(54) WEEDLESS GUARD FOR FISHING NEEDLE AND FISHING NEEDLE INCLUDING SAME

(71) Applicant: JONG GI KIM, Daejeon (KR)

(72) Inventor: JONG GI KIM, Daejeon (KR)

(21) Appl. No.: 17/119,911

(22) Filed: Dec. 11, 2020

(30) Foreign Application Priority Data
Mar. 9, 2020 (KR) 10-2020-0028770

(51) Int. Cl. A01K 85/02

(52) U.S. Cl. CPC A01K 85/02

(57) ABSTRACT

Disclosed is a technology designed to prevent obstacles from getting caught in a fishing needle by covering the fishing needle using a weedless guard, and more particularly, to a weedless fishing needle including: needle covers in which wires formed of a plasticity material and having one fixed end are arranged to be expanded at a predetermined angle; and a fixture integrally formed with the fixed end of the needle covers and coupled to a fishing needle neck, wherein the fixture is coupled to the fishing needle neck of the fishing needle so as to be detachably inserted into the fishing needle neck, in which the fixture is formed of a flexible material and has a tubular or O-ring shape, and the needle cover includes needle covers arranged side by side, and is disposed to cover a periphery of a hook of the fishing needle.

### CROSS-REFERENCE TO RELATED APPLICATIONS

This application claims the priority of Korean Patent Application No. 10-2020-0028770 filed on Mar. 9, 2020, in the Korean Intellectual Property Office, the disclosure of which is incorporated herein by reference.

### BACKGROUND OF THE INVENTION

### 1. Field of the Invention

The present invention relates to a weedless guard for a fishing needle and a fishing needle including the same to prevent a foreign substance such as aquatic plant from being hooked in the fishing needle during fishing,

More particularly, the present invention relates to a weedless guard applied to various fishing needles such as a travel hook, a jig head, a rubber jig, a Tai-rubber used in freshwater fishing, sea fishing, lure fishing, and the like so as to prevent a foreign substance from being hooked by the fishing needle during fishing, and relates to a fishing needle integrated with the weedless guard.

### 2. Description of the Related Art

In general, a fishing needle is one of the most important components in fishing. When a fishing needle tied to a tip of a fishing line is thrown into the water, the fishing needle sinks due to the weight of a lead sinker. In the case that the fishing line is pulled when a fish bites a bait stuck in the fishing needle and naturally gets caught on the fishing needle or when the fish tries to bite, a hook protruding in the reverse direction of the fishing needle keeps a state hooked in a mouth of the fish. Thus, the fish is pulled out while hooked in the fishing needle. Since the fishing needle is in a state stuck in the mouth of the fish when the fish is pulled out of the water while hooked in the fishing needle, the fishing needle is not latched in plants or bedrocks. However, when the bait in the fishing needle is replaced or a location of the fishing needle in the water is changed, the sharp hook of the fishing needle is caught at the plants or bedrocks while the fishing needle is pulled out of the water, and accordingly the fishing line is cut.

The conventional weedless device for solving the underwater hooking problem is configured to be formed of an elastic material that covers the hook of the fishing needle. However, the conventional weedless device having a predetermined size and a predetermined elastic force cannot correspond to sizes or shapes of various baits. As shown in FIG. 5, the weedless device for covering the fishing needle may be blocked by a large-sized bait, thereby causing a problem that the fishing needle cannot be hooked in the mouth of the fish. Due to the above problem, many anglers are having difficulty in fishing, and the conventional weedless fishing needles are not widely used by the anglers.

(Patent Document 1) Korean Utility Model Registration No. 20-0396046 (Registered on Sep. 9, 2005)

### SUMMARY OF THE INVENTION

The present invention provides a weedless guard for a fishing needle to prevent a foreign substance from being caught in a fishing needle and allow a fish to easily bite the fishing needle so as to be easily adjusted in various shapes and strengths according to various fishing environments or anglers tastes.

The present invention further provides a fishing needle to which a weedless guard is mounted.

In order to solve the above problem, the weedless guard for a fishing needle according to the present invention includes: a plurality of needle covers (12) in which a plurality of wires (W) formed of a plasticity material and having one fixed end are arranged to be expanded at a predetermined angle; and a fixture (11) integrally formed with the fixed end of the needle covers 12 and coupled to a fishing needle neck (22).

The wire of the weedless guard for the fishing needle according to the present invention may have plastic properties without elastic properties, so that the wire may be freely modified and used in response to various fishing environments, target fish species, or anglers' fishing preferences.

The weedless guard for the fishing needle according to the present invention may prevent a foreign substance from being caught in the fishing needle and allow the fish to easily bite the bait.

### BRIEF DESCRIPTION OF THE DRAWINGS

FIG. 1 is a perspective view showing one embodiment of a weedless guard according to the present invention.

FIG. 2 is a fishing needle coupled to the weedless guard according to the present invention.

FIG. 3 is a state diagram in which the fishing needle in FIG. 2 is inserted into a bait.

FIG. 4A and FIG. 4B show examples in which the weedless guards according to the present invention are installed.

FIG. 5 shows an example of a conventional weedless guard and an example of a mounted bait.

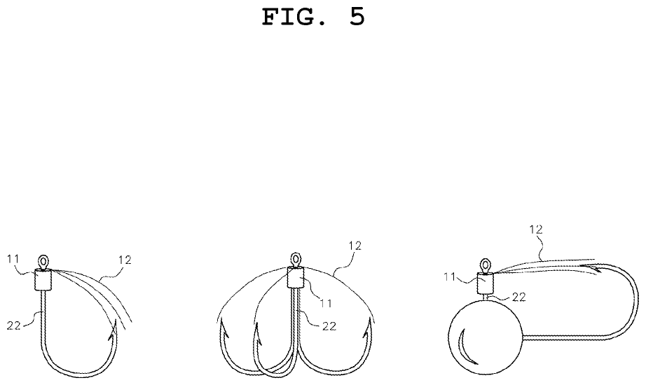

### DETAILED DESCRIPTION OF THE EXEMPLARY EMBODIMENTS

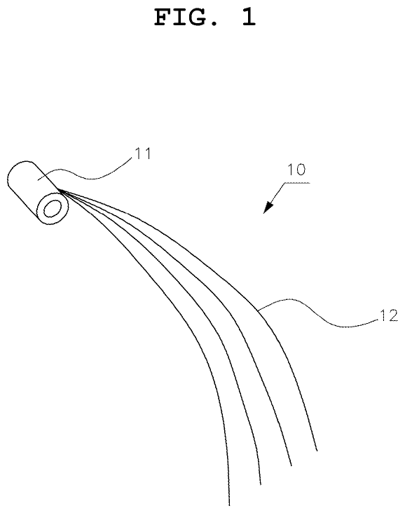

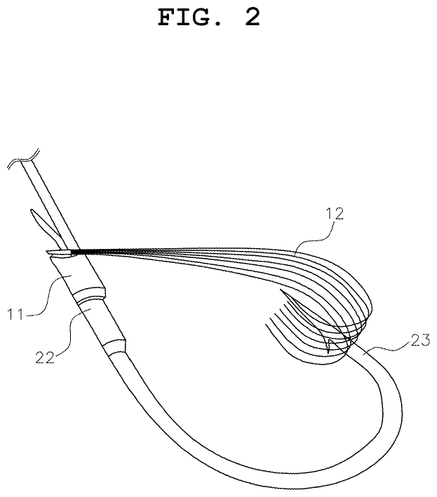

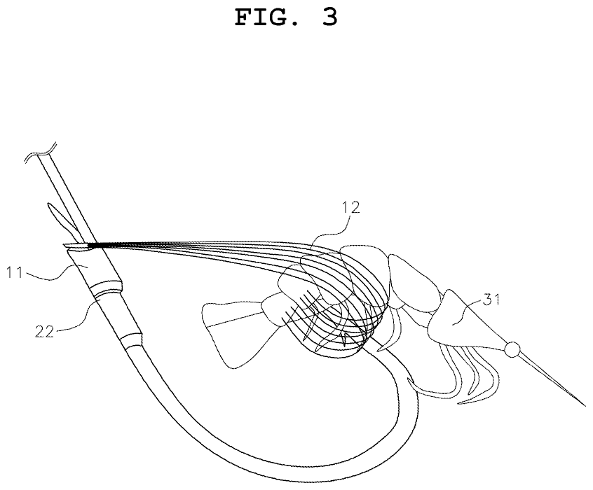

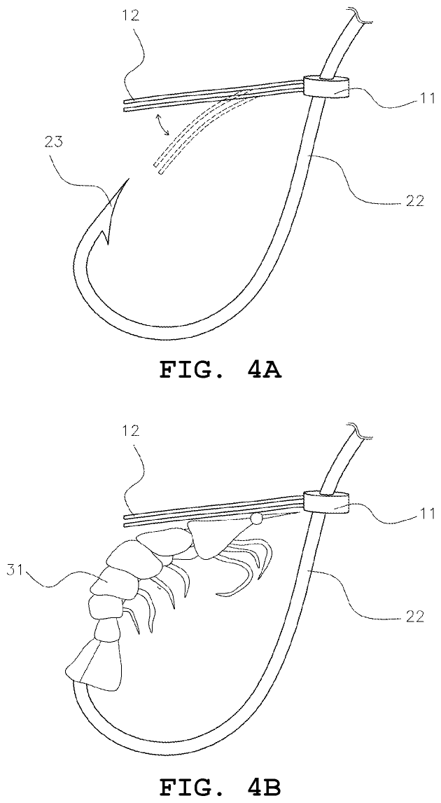

Hereinafter, the present invention will be described in detail with reference to FIGS. 1 to 4B.

One embodiment of the present invention relates to a weedless guard 10 mounted to a fishing needle, and another embodiment relates to a fishing needle to which the above weedless guard is mounted.

The weedless guard of the above embodiment includes a fixture 11 and a needle cover 12. The fixture 11 may be fixed to one end of the needle cover 12 formed of a plurality of plastic wires, have a tube shape or an O-ring shape, and be formed of an elastic material. A fishing needle neck 22 may pass through an inside of fixture 11 having the tubular or O-ring shape, and the fixture 11 may be connected to an outside of the fishing needle neck 22 while coming into close contact with the outside of the fishing needle neck 22.

The wires used for the needle cover 12 may include wires that are not thick but thin. The wire may preferably have a diameter about 0.01 mm to about 1 mm. The needle cover 12 has one end fixed to the fixture 11 and the other end covering a periphery of an upper end of the fishing needle 23, so that the fishing needle may be prevented from being caught in obstacles such as aquatic plants.

The needle cover 12 may have a plasticity in which the needle cover 12 is deformed by an external force, and is not restored to an original shape when the external force is removed. The wire having a plasticity other than having an elasticity is chosen for the needle cover. In other words, the elasticity refers to the property that an object is deformed by an external force acting thereon and then restored to an original shape when the external force is removed, whereas the plasticity refers to the property that an object is deformed by an external force acting thereon and is not restored to an original shape when the external force is removed. Accordingly, the needle cover formed of the wire having the plasticity is fixed to a predetermined position by the user's external force while being coupled to the fishing needle, so that a shape of the needle cover may be adjusted according to a shape or size of a bait.

The present invention provides a fishing needle applied with the weedless guard, and may be configured variously according to coupled schemes. In other words, the weedless guard 10 may be directly integrated and fixed to the fishing needle neck, or may be detachably coupled to the fishing needle neck 22 by using the fixture 11. The first approach has the advantage in that one weedless guard 10 may be applied to various fishing needles, and the second approach is convenient in use because the needle cover 12 is fixed to the fishing needle neck 22.

According to the present invention, since the needle cover 12 is composed of a plurality of plastic thin wires, the needle cover 12 may be freely bent or unfolded, and if necessary, may be partially cut out to form a wanted shape. In other words, when a bait 31 is covering the fishing needle 23, the shape of the wire of the needle cover may be modified and used so as not to be disturbed by the bait 31 by bending, unfolding, or cutting the needle cover 12. The strength of the needle cover 12 is set such that obstacles are prevented from entering the inside of the fishing needle 24, and the needle cover 12 is bent toward the inside 24 of the fishing needle when a fish bites the fishing needle, thereby causing a mouth of the fish to get caught on the fishing needle.

What is claimed is:

1. A weedless guard for a fishing needle, the weedless guard comprising:
a plurality of needle covers (12) in which a plurality of wires (W) formed of a plasticity material and having one fixed end are arranged to be expanded at a predetermined angle; and
a fixture (11) integrally formed with the fixed end of the needle covers (12) and coupled to a fishing needle neck (22).

2. The weedless guard of claim 1, wherein the fixture (11) is formed of an elastic material to be detachably inserted into the fishing needle neck (22) and has a tube shape or an O-ring shape.

3. A weedless fishing needle comprising:
a plurality of needle covers (12) in which a plurality of wires (W) formed of a plasticity material and having one fixed end are arranged to be expanded at a predetermined angle; and
a fixture (11) integrally formed with the fixed end of the needle covers (12) and coupled to a fishing needle neck (22), wherein
the fixture (11) is coupled to the fishing needle neck of the fishing needle so as to be detachably inserted into the fishing needle neck, in which the fixture (11) is formed of a flexible material and has a tube shape or an O-ring shape, and wherein
the needle cover (12) includes a plurality of needle covers arranged side by side, and is disposed to cover a periphery of a hook of the fishing needle.

4. The weedless fishing needle of claim 3, wherein the wire (W) has a diameter of 0.01 mm to 1 mm.
